(19) United States
(12) Patent Application Publication
(10) Pub. No.: US 2007/0149710 A1
(43) Pub. Date: Jun. 28, 2007

(54) Coagent-mediated, grafted copolymers and preparation method

(75) Inventors: Bharat I. Chaudhary, Princeton, NJ (US); Genaro A. Gutierrez, Missouri City, TX (US); Malcolm F. Finlayson, Houston, TX (US); Stephen F. Hahn, Lake Jackson, TX (US); John Scott Parent, Kingston (CA); Saurav S. Sengupta, Kingston (CA)

Correspondence Address: THE DOW CHEMICAL COMPANY, INTELLECTUAL PROPERTY SECTION,, P. O. BOX 1967, MIDLAND, MI, 48641-1967, US

(73) Assignees: Dow Global Technologies Inc., Midland, MI (US); Queen's University at Kingston, Kingston (CA)

(21) Appl. No.: 11/592,523

(22) Filed: Nov. 3, 2006

Related U.S. Application Data
(60) Provisional application No. 60/733,348, filed on Nov. 4, 2005.

(51) Int. Cl. C08F 297/02

(52) U.S. Cl. 525/242

(57) ABSTRACT

The present invention yields a coagent-mediated, grafted copolymer prepared from a free radical-mediated reaction of a mixture containing or made from (a) a first free-radical reactive organic polymer, (b) a second free-radical reactive organic polymer, and (c) a coagent selected from the group consisting of allyl, vinyl, and acrylate coagents, wherein the first and second organic polymers are chemically dissimilar polymers as determined by at least one physical property yet the organic polymers have similar reactivity in radical-mediated additions to the coagent.

### FIELD OF THE INVENTION

This invention relates to copolymer grafting. Particularly, this invention relates to the free-radical initiated grafting of at least two polymers together through an allyl, vinyl, or acrylate coagent.

### DESCRIPTION OF THE PRIOR ART

Polymeric composites and blends have many applications. Polyolefinic and polystyrenic composites and blends are of particular commercial interest. Notable polyolefins are polyethylene, polypropylene, ethylene/propylene rubbers, and polyisobutylene.

Polymeric blends are particularly desirable because the processing characteristics or the finished products of the polymeric blends take advantage of the blend's balanced properties. However, in many cases, a desired polymeric blend cannot be prepared because (i) the polymers are immiscible or incompatible, (ii) the polymeric blend will only exhibit a narrow range of properties, or (iii) deleterious effects will occur if certain polymer dispersion limits are not carefully managed.

### SUMMARY OF THE INVENTION

It is desirable to provide a polymeric composition that overcomes the inherent immiscibility or incompatibility limitations of the underlying polymers. It is further desirable to broaden the range of properties beyond those presently achievable with conventional polymeric blends. It is even further desirable to provide a polymeric composition that prevents deleterious effects while increasing the polymer dispersion limits presently observed with conventional polymeric blends.

Specifically, it is desirable to provide a grafted copolymer, which achieves the previously described attributes.

In its preferred embodiment, the present invention yields a coagent-mediated, grafted copolymer prepared from a free radical-mediated reaction of a mixture comprising (a) a first free-radical reactive organic polymer, (b) a second free-radical reactive organic polymer, and (c) a coagent selected from the group consisting of allyl, vinyl, and acrylate coagents, wherein the first and second organic polymers are chemically dissimilar polymers as determined by at least one physical property yet the organic polymers have similar reactivity in radical-mediated additions to the coagent.

The grafted copolymers of the present invention can be used as interfacial compatibilizers between dissimilar materials to improve properties such as clarity, stiffness, toughness, and stress whitening. The grafted copolymers of the present invention can have unique properties, generally not achievable with single polymers or the simple blends of polymers. For example, a resulting copolymer of polyethylene and polypropylene could have the low temperature toughness of the polyethylene combined with the high upper service temperature of the polypropylene. Similarly, a grafted copolymer could exhibit high melt strength coupled with good strain hardening characteristics during melt extensional flow.

The enhanced solid and melt state properties of the graft copolymers can also make them suitable as single or majority blend components in polymer processing and fabrication. This invention is useful for the fabrication of different articles by various processes such as extrusion and blow molding and in certain applications such as foams and wire and cable compounds or constructions.

The invention further provides a process for the free-radical initiated grafting of copolymers. The processes can include melt state or in solution free-radical initiated grafting.

### BRIEF DESCRIPTION OF DRAWING

FIG. 1 shows the FT-IR spectrum of the Xylene-Soluble Fraction of a coagent-mediated, grafted copolymer of polypropylene and polyethylene.

FIG. 2 shows the DSC of the Xylene-Soluble Fraction of a coagent-mediated, grafted copolymer of polypropylene and polyethylene.

FIG. 3 shows the FT-IR spectrum of the Xylene-Insoluble Fraction of a coagent-mediated, grafted copolymer of polypropylene and polyethylene.

FIG. 4 shows the DSC of the Xylene-Insoluble Fraction of a coagent-mediated, grafted copolymer of polypropylene and polyethylene.

FIG. 5 shows the relative yield of allyl benzoate grafting to four polymers, polypropylene, polyethylene, polyethylene glycol, and an ethylene/vinyl acetate copolymer.

### DESCRIPTION OF THE INVENTION

In a preferred embodiment, the present invention is a coagent-mediated, grafted copolymer prepared from a free radical-mediated reaction of a mixture comprising (a) a first free-radical reactive organic polymer, (b) a second free-radical reactive organic polymer, and (c) a coagent selected from the group consisting of allyl, vinyl, and acrylate coagents, wherein the first and second organic polymers are chemically dissimilar polymers as determined by at least one physical property yet the organic polymers have similar reactivity in radical-mediated additions to the coagent.

The free-radical reactive organic polymers can be subject to (i) hydrogen atom abstraction in the presence of oxygen-centered free radicals or carbon-centered free radicals or (ii) undergoing free-radical formation when subjected to shear heat, thermal energy, or radiation. Suitable free-radical reactive organic polymers include such polymers as ethylene/propylene/diene monomers, ethylene/propylene rubbers, ethylene/alpha-olefin copolymers, ethylene homopolymers, propylene homopolymers, ethylene/unsaturated ester copolymers, ethylene/styrene interpolymers, halogenated polyethylenes, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, nitrile rubber, polyethers, polyamides, polyesters, ethylene co-(acrylic or methacrylic acid) interpolymers and their derived ionomers, and functionalized derivatives of these polymers.

With regard to the suitable ethylene polymers, the polymers generally fall into four main classifications: (1) highly-branched; (2) heterogeneous linear; (3) homogeneously branched linear; and (4) homogeneously branched substantially linear. These polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers have a density between about 0.910 grams per cubic centimeter and about 0.940 grams per cubic centimeter as measured by ASTM D-792.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers have a density between about 0.850 grams per cubic centimeter and about 0.940 grams per cubic centimeter and a melt index between about 0.01 to about 100 grams per 10 minutes as measured by ASTM 1238, condition I. Preferably, the melt index is between about 0.1 to about 50 grams per 10 minutes. Also, preferably, the LLDPE is an interpolymer of ethylene and one or more other alpha-olefins having from 3 to 18 carbon atoms, more preferably from 3 to 8 carbon atoms. Preferred comonomers include 1-butene, 4-methyl-1-pentene, 1-hexene, and 1-octene.

Ultra-low density polyethylene and very low density polyethylene are known interchangeably. These polymers have a density between about 0.870 grams per cubic centimeter and about 0.910 grams per cubic centimeter. High density ethylene polymers are generally homopolymers with a density between about 0.941 grams per cubic centimeter and about 0.965 grams per cubic centimeter.

Homogeneously branched linear ethylene polymers include homogeneous LLDPE. The uniformly branched/homogeneous polymers are those polymers in which the comonomer is randomly distributed within a given interpolymer molecule and wherein the interpolymer molecules have a similar ethylene/comonomer ratio within that interpolymer.

Homogeneously-branched substantially linear ethylene polymers include (a) homopolymers of C₂-C₂₀ olefins, such as ethylene, propylene, and 4-methyl-1-pentene, (b) interpolymers of ethylene with at least one C₃-C₂₀ alpha-olefin, C₂-C₂₀ acetylenically unsaturated monomer, C₄-C₁₈ diolefin, or combinations of the monomers, and (c) interpolymers of ethylene with at least one of the C₃-C₂₀ alpha-olefins, diolefins, or acetylenically unsaturated monomers in combination with other unsaturated monomers. These polymers generally have a density between about 0.850 grams per cubic centimeter and about 0.970 grams per cubic centimeter. Preferably, the density is between about 0.85 grams per cubic centimeter and about 0.955 grams per cubic centimeter, more preferably, between about 0.850 grams per cubic centimeter and 0.920 grams per cubic centimeter.

Ethylene/styrene interpolymers useful in the present invention include substantially random interpolymers prepared by polymerizing an olefin monomer (i.e., ethylene, propylene, or alpha-olefin monomer) with a vinylidene aromatic monomer, hindered aliphatic vinylidene monomer, or cycloaliphatic vinylidene monomer. Suitable olefin monomers contain from 2 to 20, preferably from 2 to 12, more preferably from 2 to 8 carbon atoms. Preferred such monomers include ethylene, propylene, 1-butene, 4-methyl-1-pentene, 1-hexene, and 1-octene. Most preferred are ethylene and a combination of ethylene with propylene or C₄₋₈ alpha-olefins. Optionally, the ethylene/styrene interpolymers polymerization components can also include ethylenically unsaturated monomers such as strained ring olefins. Examples of strained ring olefins include norbornene and Cₗ₋ alkyl- or C₆₋₁₀ aryl-substituted norbornenes.

Ethylene/unsaturated ester copolymers useful in the present invention can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of about 5 to about 50 percent by weight based on the weight of the copolymer, and is preferably in the range of about 15 to about 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of about 0.5 to about 50 grams per 10 minutes.

Halogenated ethylene polymers useful in the present invention include fluorinated, chlorinated, and brominated olefin polymers. The base olefin polymer can be a homopolymer or an interpolymer of olefins having from 2 to 18 carbon atoms. Preferably, the olefin polymer will be an interpolymer of ethylene with propylene or an alpha-olefin monomer having 4 to 8 carbon atoms. Preferred alpha-olefin comonomers include 1-butene, 4-methyl-1-pentene, 1-hexene, and 1-octene. Preferably, the halogenated olefin polymer is a chlorinated polyethylene.

Examples of propylene polymers useful in the present invention include propylene homopolymers and copolymers of propylene with ethylene or another unsaturated comonomer. Copolymers also include terpolymers, tetrapolymers, etc. Typically, the polypropylene copolymers comprise units derived from propylene in an amount of at least about 60 weight percent. Preferably, the propylene monomer is at least about 70 weight percent of the copolymer, more preferably at least about 80 weight percent.

Natural rubbers suitable in the present invention include high molecular weight polymers of isoprene. Preferably, the natural rubber will have a number average degree of polymerization of about 5000 and a broad molecular weight distribution.

Useful styrene/butadiene rubbers include random copolymers of styrene and butadiene. Typically, these rubbers are produced by free radical polymerization. Styrene/butadiene/styrene block copolymers of the present invention are a phase-separated system. The styrene/ethylene/butadiene/styrene copolymers useful in the present invention are prepared from the hydrogenation of styrene/butadiene/styrene copolymers.

Examples of polybutadiene rubbers useful in the present invention include polymers that contain either the 1,4-butadiene or the 1,2-butadiene repeat unit solely or where both repeat unit types are present, and where the 1,4-butadiene repeat unit can exist in either the cis or trans configuration. Preferably, the butyl rubber of the present invention is a copolymer of isobutylene and isoprene. The isoprene is typically used in an amount between about 1.0 weight percent and about 3.0 weight percent.

For the present invention, polychloroprene rubbers are generally polymers of 2-chloro-1,3-butadiene. Preferably, the rubber is produced by an emulsion polymerization. Additionally, the polymerization can occur in the presence of sulfur to incorporate crosslinking in the polymer.

Preferably, the nitrile rubber of the present invention is a random copolymer of butadiene and acrylonitrile.

The selection of the first and second polymers depends upon the polymers having similar reactivity in free-radical-mediated additions to the coagent. For example, when the selected coagent is an allyl coagent, a suitable method for determining a polymer's free radical reactivity is by measuring the polymer's allyl benzoate graft yield. This quantity can be evaluated by spectroscopic measurements of the aromatic ester content within the purified product of a peroxide-initiated reaction of allyl benzoate and the polymer of interest. Those polymer derivatives that contain a relatively large amount of bound aromatic ester are more reactive with respect to the radical-mediated addition of allyl coagents.

Based upon the present description, a person skilled in the art could readily determine other measurements for free radical reactivity based upon the selected allyl coagent. Similarly, test methods for determining a polymer free-radical reactivity in the presence of vinyl- or acrylate-based coagents can be readily developed based upon this application. As such, those measurements are considered within the scope of the present invention.

When allyl benzoate graft yield is used as the criterion for determining the similarity of the polymers' free radical reactivity, the polymers must have graft yields which differ by no more than 300 percent. Preferably, the graft yields would differ by no more than 200 percent. More preferably, the graft yields would differ by no more than 100 percent. Similar graft yields should be achieved when the coagent is vinyl- or acrylate-based for the relevant comparative methods.

With regard to suitable allyl-based coagents, useful coagents include triallyl trimellitate (TATM), triallyl phosphate (TAP), pentaerythritol diallyl ether (PE(Di)AE), pentaerythritol triallyl ether (PE(Tri)AE), pentaerythritol tetraallyl ether (PE(Tetra)AE), triallyl trimesate, triallyl cyanurate, and mixtures thereof. An example of suitable vinyl coagents is divinylbenzene. Examples of suitable acrylate-based coagents or methacrylate coagents are pentaerythritoltriacrylate (PETA), trimethylolpropanetriacrylate (TMPTAc), 1,4-butanediol diacrylate (BDDA), ethylene glycol dimethacrylate and 1,6-hexanediol diacrylate (HDDA).

The coagent would preferably be present in amount in the range from about 0.05 weight percent to about 20.0 weight percent. More preferably, the coagent would be present in amount between about 0.1 weight percent and about 10.0 weight percent. Even more preferably, the coagent would be present in amount between about 0.3 weight percent and about 5.0 weight percent.

The oxygen-centered free radicals or carbon-centered free radicals can be formed in a variety of ways. For example, oxygen-centered free radicals may occur through the use of organic peroxides, Azo free radical initiators, bicumene, oxygen, and air. In this regard, the mixture may further comprise an organic peroxide, an Azo free radical initiator, bicumene, oxygen, or air. When an organic peroxide is used, the organic peroxide is generally present in an amount between about 0.005 weight percent and about 20.0 weight percent, more preferably, between about 0.01 weight percent and about 10.0 weight percent, and even more preferably, between about 0.03 weight percent and about 5.0 weight percent.

For example, carbon-centered free radicals may occur from alkoxy radical fragmentation, allyl coagent activation, and chain-transfer to the free-radical reactive polymer.

In an alternate embodiment, the present invention is a grafted copolymer prepared from a free radical-mediated reaction of mixture comprising (a) a first free-radical reactive organic polymer having grafted thereto a coagent selected from the group consisting of allyl, vinyl, and acrylate coagents and (b) a second free-radical reactive organic polymer, wherein the first and second organic polymers are chemically dissimilar polymers as determined by at least one physical property yet the organic polymers have similar reactivity in radical-mediated additions to the coagent.

Preferably, the first organic polymer prior to grafting with the coagent demonstrates a lower free radical reactivity than the second organic polymer.

It is believed that the copolymer yield in systems whose polymer components differ widely in terms of coagent addition reactivity can be improved by functionalizing the less reactive material prior to the copolymer synthesis. This functionalization involves a radical-mediated graft addition of a coagent such that the polymer derivative contains residual allyl, vinyl, or acrylate groups. This functionalization process transforms the less reactive polymer into a macromolecular coagent, which when activated during a copolymer synthesis, will engage the highly reactive polymer preferentially to generate the desired copolymer product in good yield.

In yet another embodiment, the present invention is a process for preparing the coagent-mediated, grafted copolymer. The process may occur in a melt state if the polymers are completely miscible or partially miscible at the grafting reaction temperature. The process may also occur in solution. When the process occurs in solution, preferably the selected solvent will render the first organic polymer, the second organic polymer, and the coagent fully soluble to form a single-phase mixture. However, a person skilled in the art would recognize that the in-solution process may occur when the mixture components demonstrate at least partial miscibility in the solvent.

In yet another embodiment, the present invention is an article of manufacture prepared from the coagent-mediated, grafted copolymer. Any number of processes can be used to prepare the articles of manufacture. Specifically useful processes include injection molding, extrusion, compression molding, rotational molding, thermoforming, blowmolding, powder coating, Banbury batch mixers, fiber spinning, and calendaring.

Suitable examples of the present embodiment include wire-and-cable insulations, wire-and-cable semiconductive articles, wire-and-cable coatings and jackets, cable accessories, shoe soles, multicomponent shoe soles (including polymers of different densities and type), weather stripping, gaskets, profiles, durable goods, rigid ultradrawn tape, run flat tire inserts, construction panels, composites (e.g., wood composites), pipes, foams, blown films, and fibers (including binder fibers and elastic fibers).

Suitable foam products include, for example, extruded thermoplastic polymer foam, extruded polymer strand foam, expandable thermoplastic foam beads, expanded thermoplastic foam beads, expanded and fused thermoplastic foam beads, and various types of crosslinked foams. The foam products may take any known physical configuration, such as sheet, round, strand geometry, rod, solid plank, laminated plank, coalesced strand plank, profiles, and bun stock.

### EXAMPLES

The following non-limiting examples illustrate the invention.

### Example 1

A graft copolymer was prepared from homopolymer (isotactic) polypropylene and polyethylene having a number average molecular weight of 1700 through a peroxide-initiated cografting of triallyl trimellitate (TATM). The polypropylene was an experimental reactor isotactic homopolymer polypropylene powder (PP) made by The Dow Chemical Company. The properties of this resin were as follows: Melt Flow Rate (MFR) of 3.14 g/10 min; DSC Melting Point of 167.1 degrees Celsius; and a Bulk Density of 0.47 g/cc.

PP (1 gm), PE (1 gm), and trichlorobenzene (20 ml) were heated to 150 degrees Celsius in an oil bath, resulting in a clear solution. TATM (0.06 gm, 3 weight percent) and dicumyl peroxide (DCP) (0.002 gm, 0.1 weight percent) were added and the mixture was maintained at 150 degrees Celsius for 60 minutes. Polymeric reaction products were recovered by precipitating from acetone (50 ml), and the resulting sample was dried under vacuum.

To fractionate the reaction product, the dried polymer was stirred in xylenes (25 ml) at 140 degrees Celsius to produce a clear solution. The solution was immersed in an oil bath at 70 degrees Celsius and stirred for 1 hr, resulting in the appearance of a swollen solid phase within a clear solution. The clear solution was decanted and the xylene soluble fraction was precipitated in acetone (100 ml). The swollen solid phase went through a second step of xylene extraction to ensure removal of all xylene soluble components.

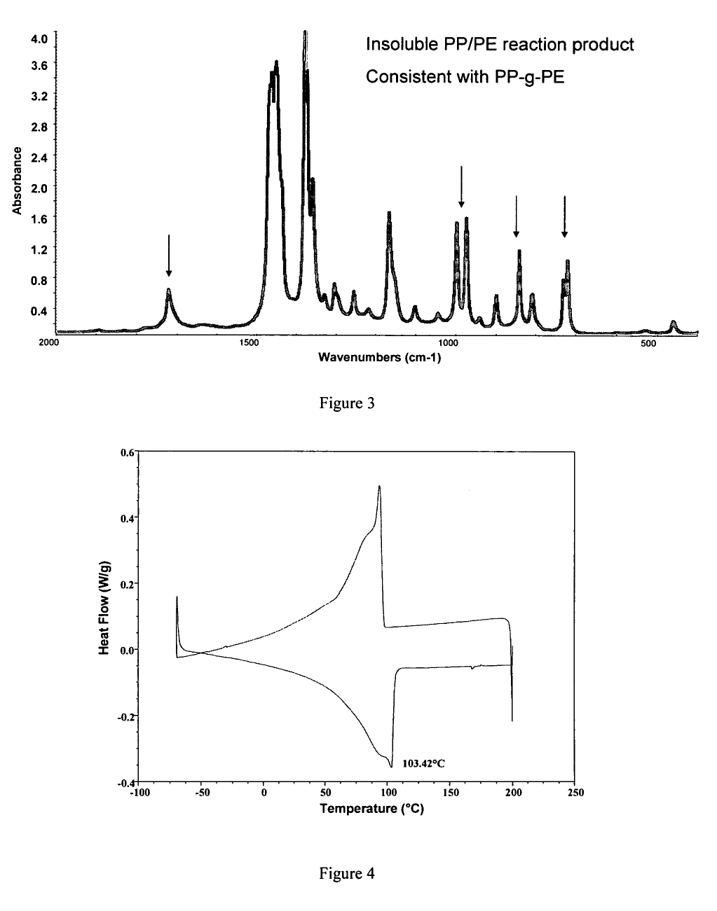

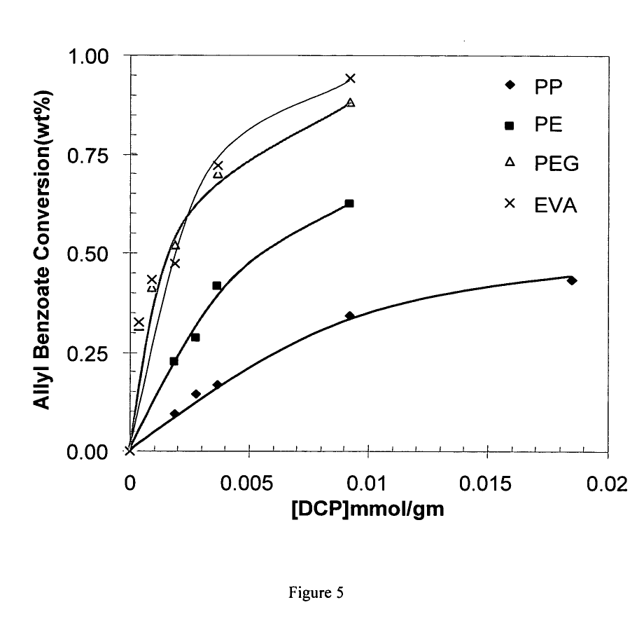

The swollen solid phase was purified by re-dissolving in xylene (20 ml) and precipitating in acetone (80 ml). FT-IR analysis of this fraction revealed the characteristic resonances of both PE (719 cm⁻¹) and PP (843 cm⁻¹ and 999 cm⁻¹) and also the characteristic carbonyl resonance of grafted ester at 1724 cm⁻¹, i.e., evidence of graft copolymer (PP-g-PE) (FIG. 3). DSC analysis of this swollen solid phase revealed two transition temperatures at 103.2 degrees Celsius and 159.9 degrees Celsius (FIG. 4). Gravimetric analysis on all the recovered components revealed that, of the 1 g of PE charged to the reaction vessel, approximately 0.29 g of PE was rendered insoluble as a result of the grafting process. This indicates that the PE/PP ratio was 0.29 in the swollen solid phase.

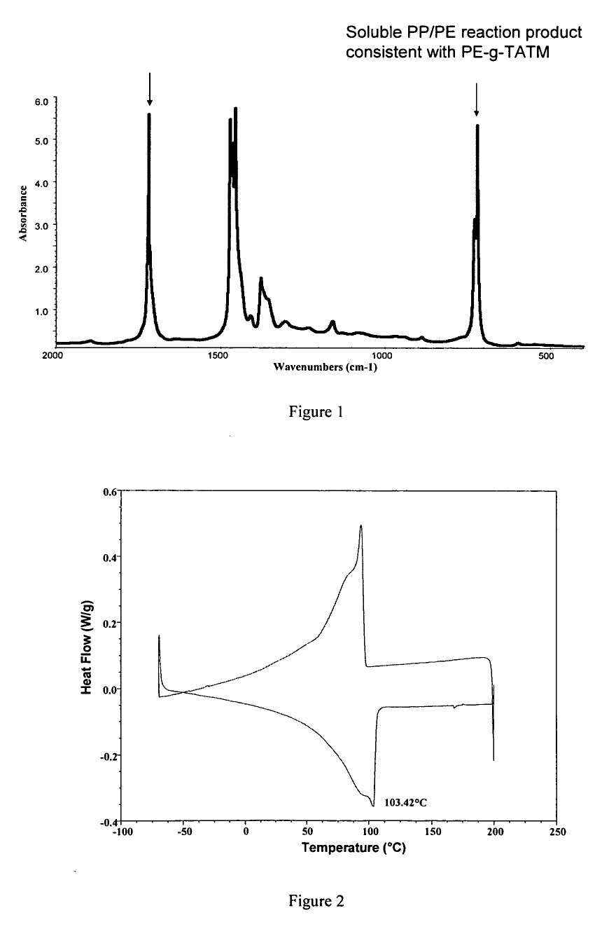

FT-IR analysis of the xylene soluble fraction revealed the characteristic PE resonance at 719 cm⁻¹ and the characteristic carbonyl resonance of grafted ester at 1724 cm⁻¹ (FIG. 1). DSC analysis on this sample showed a Tₘ of 106 degrees Celsius which is consistent with PE-g-TATM (FIG. 2).

### Example 2

As previously described, the preparation of coagent-mediated, grafted copolymers is dependent on the relative free-radical reactivity of the organic polymers, particularly toward allyl group addition. The reactivity of four materials of interest has been assessed by a series of peroxide-mediated addition reactions of allyl benzoate (AB). Isotactic polypropylene homopolymer and polyethylene (PE, Mn=1,700, Sigma-Aldrich) were purified prior to use by dissolution/precipitation (xylenes/acetone). Polyethylene oxide (PEO, Mn=5000, Alfa-Aeser) and an ethylene-vinyl acetate copolymer (EVA, 25 weight percent VA, Scientific Polymers Products) were purified by dissolution/precipitation (trichlorobenzene/acetone). Allyl benzoate (AB, 99 percent, TCI), and dicumylperoxide (DCP, 98 percent, Sigma-Aldrich) were used as received.

The grafting of AB to each polymer was conducted according to the following procedure. The desired polymer (1 gm) was dissolved in trichlorobenzene (20 ml) at 150° C. Allyl benzoate (0.05 gm) and required amount of dicumylperoxide were added to the polymer solution and the mixture was stirred at 150 degrees Celsius for 60 min. The polymer was precipitated from acetone (100 ml) filtered and dried under vacuum. In the case of PP, PE and PEO products, thin films of the purified materials were analyzed using a Nicolet Avatar 360 FT-IR ESP spectrometer. The bound AB content for each polymer was determined from the area derived from the 1670-1751 cm⁻¹ resonance of the bound carbonyl relative to 491-422 cm⁻¹ of PP, 2100-1986 cm⁻¹ of PE and 2287-2119 cm⁻¹ of PEO. Instrument calibrations were developed using known mixtures of the polymers and butylbenzoate. The bound allyl benzoate content for modified EVA samples was determined by ¹H-NMR. Quantitative integration of ¹H-NMR spectra was accomplished by charging known amounts of tetrabutylammonium bromide to samples to serve as an internal standard. The ester peak from bound coagent (δ 4.20-4.35 ppm) was integrated relative to the internal standard (δ 3.31-3.44 ppm) to derive allyl benzoate conversions for the EVA system.

The results are presented in FIG. 5. Distinct differences were observed in reactivity towards allyl group grafting for different polymers. The selectivity of coagent addition would be reflected on copolymer formation. Polymers with similar reactivity towards allyl group addition will form copolymers with greater ease (e.g., PP-g-PE or PEO-g-EVA). It is believed that polymers with large differences in reactivity towards allyl group addition will not form copolymers as readily (e.g., PP/EVA or PP/PEG) because the more reactive polymer will be preferentially grafted (e.g., EVA or PEO).

What is claimed:

1. A coagent-mediated, grafted copolymer prepared from a free radical-mediated reaction of a mixture comprising:
(a) a first free-radical reactive organic polymer;
(b) a second free-radical reactive organic polymer; and
(c) a coagent selected from the group consisting of allyl, vinyl, and acrylate coagents,
wherein the first and second organic polymers are chemically dissimilar polymers as determined by at least one physical property yet the organic polymers have similar reactivity in radical-mediated additions to the coagent.

2. The coagent-mediated, grafted copolymer of claim 1 wherein at least one of the free-radical reactive organic polymers is subject to hydrogen atom abstraction in the presence of oxygen-centered free radicals or carbon-centered free radicals.

3. The coagent-mediated, grafted copolymer of claim 1 wherein at least one of the free-radical reactive organic polymers is subject to free-radical formation when subjected to shear heat, thermal energy, or radiation.

4. The coagent-mediated, grafted copolymer of claim 1 wherein the coagent is selected from the group consisting of triallyl trimellitate, triallyl phosphate, pentaerythritol diallyl ether, pentaerythritol triallyl ether, pentaerythritol tetraallyl ether, triallyl trimesate, triallyl cyanurate, and mixtures thereof.

5. The coagent-mediated, grafted copolymer of claim 1 wherein the coagent is divinylbenzene.

6. The coagent-mediated, grafted copolymer of claim 1 wherein the coagent is selected from the group consisting of pentaerythritoltriacrylate, trimethylolpropanetriacrylate, 1,4-butanediol diacrylate, ethylene glycol dimethacrylate, and 1,6-hexanediol diacrylate.

7. The coagent-mediated, grafted copolymer of claim 1 wherein the free-radical reactive organic polymers have similar coagent graft yields.

8. The coagent-mediated, grafted copolymer of claim 7 wherein the free-radical reactive organic polymers have similar allyl benzoate graft yields.

9. The coagent-mediated, grafted copolymer of claim 1 wherein the free-radical reactive organic polymers have graft yields differing by about 100 percent or less.

10. A coagent-mediated, grafted copolymer prepared from a free radical-mediated reaction of a mixture comprising:
(a) a first free-radical reactive organic polymer having grafted thereto a coagent selected from the group consisting of allyl, vinyl, and acrylate coagents; and
(b) a second free-radical reactive organic polymer,
wherein the first and second organic polymers are chemically dissimilar polymers as determined by at least one physical property yet the organic polymers have similar reactivity in radical-mediated additions to the coagent.

11. The coagent-mediated, grafted copolymer of claim 10 wherein the first free-radical reactive organic polymer prior to grafting with the coagent has a lower free radical reactivity than the second free-radical reactive organic polymer.

12. A process for preparing a coagent-mediated, grafted copolymer comprising the step of reactively coupling a mixture comprising
(a) a first free-radical reactive organic polymer;
(b) a second free-radical reactive organic polymer; and
(c) a coagent selected from the group consisting of allyl, vinyl, and acrylate coagents,
wherein the first and second organic polymers are chemically dissimilar polymers as determined by at least one physical property yet the organic polymers have similar reactivity in radical-mediated additions to the coagent.

13. The process according to claim 12 wherein the step occurs in a melt state.

14. The process according to claim 12 wherein the step occurs in solution.

15. A process for preparing a coagent-mediated, grafted copolymer comprising the step of reactively coupling a mixture comprising
(a) a first free-radical reactive organic polymer having grafted thereto a coagent selected from the group consisting of allyl, vinyl, and acrylate coagents; and
(b) a second free-radical reactive organic polymer,
wherein the first and second organic polymers are chemically dissimilar polymers as determined by at least one physical property yet the organic polymers have similar reactivity in radical-mediated additions to the coagent.

16. The process according to claim 15 wherein the step occurs in a melt state.

17. The process according to claim 15 wherein the step occurs in solution.

18. An article of manufacture prepared from a coagent-mediated, grafted copolymer according to claim 1.

19. An article of manufacture prepared from a coagent-mediated, grafted copolymer according to claim 10.
